(19) United States
(12) Patent Application Publication
(10) Pub. No.: US 2025/0133315 A1
(43) Pub. Date: Apr. 24, 2025

(54) OPTICAL FIBER SWITCHING NODE DEVICE

(71) Applicant: NIPPON TELEGRAPH AND TELEPHONE CORPORATION, Tokyo (JP)

(72) Inventors: Kazuhide NAKAE, Musashino-shi, Tokyo (JP); Kazunori KATAYAMA, Musashino-shi, Tokyo (JP); Ryo KOYAMA, Musashino-shi, Tokyo (JP); Hiroshi WATANABE, Musashino-shi, Tokyo (JP); Tomohiro KAWANO, Musashino-shi, Tokyo (JP); Tatsuya FUJIMOTO, Musashino-shi, Tokyo (JP)

(73) Assignee: NIPPON TELEGRAPH AND TELEPHONE CORPORATION, Tokyo (JP)

(21) Appl. No.: 18/683,677

(22) PCT Filed: Aug. 16, 2021
(86) PCT No.: PCT/JP2021/029937

§ 371 Date: Feb. 14, 2024

(51) Int. Cl. H04Q 11/00

(52) U.S. Cl. CPC H04Q 11/0071; H04Q 2011/0083; H04Q 2213/08

(57) ABSTRACT

The present disclosure is an optical line switching node device N which includes an optical switch part 2 which performs optical path switching between communication optical fibers F-0, F-1; a communication optical signal extraction part 5-0, 5-1 which extracts some of communication optical signals from one or both of the communication optical fibers F-0, F-1 and photoelectrically converts the extracted some of the communication optical signals; and a communication optical signal storage part 6 which stores some of communication optical signals photoelectrically converted in the communication optical signal extraction part 5-1, 5-1 and uses the stored energy to drive the optical switch part 2.

### TECHNICAL FIELD

The present disclosure relates to a technique for performing optical path switching between input and output optical fibers for communication.

### BACKGROUND ART

In optical fiber networks, particularly, in access networks connecting telecommunications carrier equipment and optical terminals, in order to efficiently use facilities in service opening and maintenance, optical path switching is performed at a constant frequency such as arbitrarily connecting and changing routes of optical fiber core wires.

Here, in the usual technique, a worker of the telecommunications carrier goes to the site and physically and manually switches the optical path. On the other hand, in NPL 1 and 2, laser beams are transmitted from a telecommunications carrier's building or the like, propagate through optical fiber core wires, and are photoelectrically converted using optical line switching node devices and remote optical path switching is performed using the stored energy.

### CITATION LIST

### Non Patent Literature

[NPL 1] Tomohiro KAWANO, Tatsuya FUJIMOTO, Kazuhide NAKAE, Hiroshi WATANABE, and Kazunori KATAYAMA, “Study on Remote Operated Optical Fiber Switching Node for Future Access Network”, 2021 General Conference of the Institute of Electronics, Information and Communication Engineers, B-13-16, 2021.
[NPL 2] Tatsuya FUJIMOTO, Tomohiro KAWANO, Kazuhide NAKAE, Hiroshi WATANABE, and Kazunori KATAYAMA, “Study of Optical Power Supply Efficiency for Realization of Remote Optical Path Switching Node”, 2021 General Conference of the Institute of Electronics, Information and Communication Engineers, B-13-17, 2021.

### SUMMARY OF INVENTION

### Technical Problem

However, in NPL 1 and 2, it is necessary to install devices for transmitting a laser beam in a telecommunications carrier's building or the like. Thus, there is a problem that the installation cost and the operation cost of the device for transmitting a laser beam are high. Also, in NPL 1 and 2, when a plurality of optical line switching node devices are installed in an access field, the number of optical fiber core wires for power supply increases. Thus, there is also a problem that there is a concern concerning a shortage of optical fiber core wires for communication.

Therefore, in order to solve the above problems, an object of the present disclosure is to perform remote optical path switching without installing a device which transmits a laser beam in a telecommunications carrier's building or the like and without increasing the number of optical fiber core wires for power supply in an access field.

### Solution to Problem

In order to solve the above-described problems, instead of photoelectrically converting a laser beam, an optical signal for communication is photoelectrically converted and the stored energy is used for performing remote optical path switching.

Specifically, the present disclosure is an optical line switching node device which includes: an optical switch part which performs optical path switching between communication input/output optical fibers; a communication optical signal extraction part which extracts some of communication optical signals from one or both of the communication input/output optical fibers and photoelectrically converts the extracted some of the communication optical signals; and a communication optical signal storage part which stores some of communication optical signals photoelectrically converted in the communication optical signal extraction part and uses the stored energy to drive the optical switch part.

According to this configuration, since it is sufficient that a communication optical signal is photoelectrically converted, remote optical path switching can be performed without installing a device for transmitting a laser beam in a telecommunications carrier's building or the like and without increasing the number of optical fiber core wires for power supply in an access field.

Also, the present disclosure is an optical line switching node device which further includes: an optical path switching monitoring part which extracts some of communication optical signals from the communication input/output optical fibers, photoelectrically converts some of the extracted communication optical signals, and monitors optical path switching between the communication input/output optical fibers using some of the photoelectrically converted communication optical signals, in which the communication optical signal extraction part extracts some of the communication optical signals from one or both of the communication input/output optical fibers in parallel with the optical path switching monitoring part.

According to this configuration, after installing the communication optical signal extraction part in parallel with the optical path switching monitoring part, the power storage mode and the monitoring mode can be performed at parallel timings.

Furthermore, the present disclosure is an optical line switching node device which further includes: an optical path switching monitoring part which extracts some of communication optical signals from the communication input/output optical fibers, photoelectrically converts some of the extracted communication optical signals, and monitors optical path switching between the communication input/output optical fibers using some of the photoelectrically converted communication optical signals, in which the communication optical signal extraction part extracts some of the communication optical signals from one or both of the communication input/output optical fibers through integration with the optical path switching monitoring part, and a power storage mode for some of the communication optical signals using the communication optical signal storage part and a monitoring mode for optical path switching using the optical path switching monitoring part are performed at parallel timings.

According to this configuration, after installing the communication optical signal extraction part integrally with the optical path switching monitoring part, the power storage mode and the monitoring mode can be performed at parallel timings.

In addition, the present disclosure is an optical line switching node device which further includes: an optical path switching monitoring part which extracts some of communication optical signals from the communication input/output optical fibers, photoelectrically converts some of the extracted communication optical signals, and monitors optical path switching between the communication input/output optical fibers using some of the photoelectrically converted communication optical signals, in which the communication optical signal extraction part extracts some of the communication optical signals from one or both of the communication input/output optical fibers through integration with the optical path switching monitoring part, and a power storage mode for some of the communication optical signals using the communication optical signal storage part and a monitoring mode for optical path switching using the optical path switching monitoring part are performed at alternate timings.

According to this configuration, after installing the communication optical signal extraction part integrally with the optical path switching monitoring part, the power storage mode and the monitoring mode can be performed at alternate timings.

Moreover, the present disclosure is an optical line switching node device, in which the optical path switching monitoring mode using the optical path switching monitoring part is performed at a timing at which an amount of electricity stored of some of the communication optical signals in the communication optical signal storage part is secured.

According to this configuration, the stored energy can be used to perform the monitoring mode, and if the energy is not stored, the monitoring mode can be discontinued.

Also, the present disclosure is an optical line switching node device, in which one or both of the communication input/output optical fibers are a multi-core optical fiber which includes a communication single-core optical fiber which transmits a communication optical signal and a control single-core optical fiber which transmits a control optical signal of the optical switch part.

According to this configuration, only one multi-core optical fiber needs to be prepared without separately preparing a communication single-core optical fiber and a control single-core optical fiber.

### Advantageous Effects of Invention

In this way, the present disclosure can perform remote optical path switching without installing a device which transmits a laser beam in a telecommunications carrier building or the like and without increasing the number of optical fiber core wires for power supply in an access field.

### BRIEF DESCRIPTION OF DRAWINGS

FIG. 1 is a diagram illustrating a schematic configuration of an optical line switching node device of the present disclosure.

FIG. 2 is a diagram illustrating a configuration of an optical line switching node device according to a first embodiment of the present disclosure.

FIG. 3 is a diagram illustrating a configuration of an optical line switching node device according to a second embodiment of the present disclosure.

FIG. 4 is a diagram illustrating a configuration of an optical line switching node device according to a third embodiment of the present disclosure.

FIG. 5 is a diagram for describing a procedure of an optical path switching monitoring process according to the third embodiment of the present disclosure.

FIG. 6 is a diagram illustrating a configuration of an optical path switching node device according to a fourth embodiment of the present disclosure.

### DESCRIPTION OF EMBODIMENTS

Embodiments of the present disclosure will be described with reference to the accompanying drawings. Embodiments which will be described later are examples of implementing the present disclosure and the present disclosure is not limited to the following embodiments.

### Schematic Configuration of Optical Line Switching Node Device of Present Disclosure

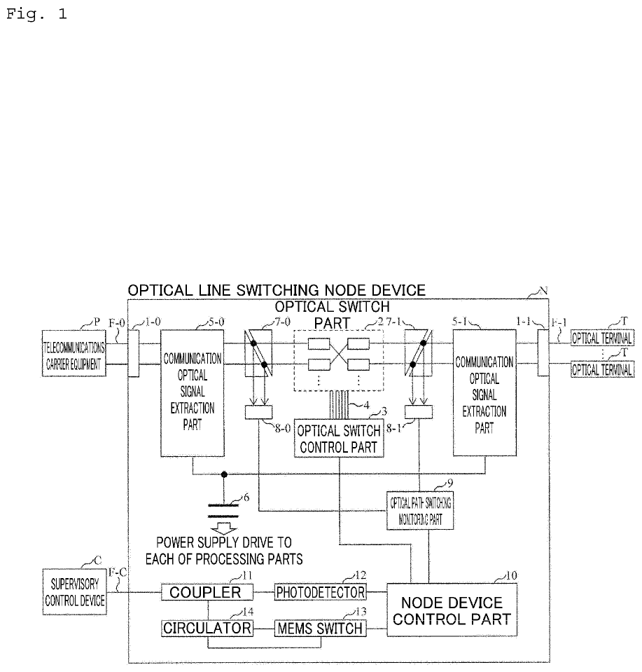

FIG. 1 illustrates a schematic configuration of an optical line switching node device of the present disclosure. An optical line switching node device N is connected to a telecommunications carrier equipment P via a communication optical fiber F-0 (0-system optical fiber of an active system or the like), connected to a plurality of optical terminals T via a communication optical fiber F-1 (an optical fiber of 1-system of a standby system or the like), and connected to a supervisory control device C via a control optical fiber F-C.

The optical line switching node device N includes integrated connectors 1-0 and 1-1, an optical switch part 2, an optical switch control part 3, an optical switch control feeder line 4, communication optical signal extraction parts 5-0 and 5-1, a communication optical signal storage part 6, prisms 7-0 and 7-1, optical sensors 8-0 and 8-1, an optical path switching monitoring part 9, a node device control part 10, a coupler 11, a photodetector 12, a MEMS switch 13, and a circulator 14 (*-0 corresponds to a 0-system of an active system and *-1 corresponds to a 1-system of a backup system).

The integrated connectors 1-0 and 1-1 integrate communication optical fibers F-0 and F-1. The optical switch part 2 (such as an N×N optical switch) performs optical path switching between the communication optical fibers F-0 and F-1. The optical switch control part 3 controls the optical switch part 2 in accordance with commands from the node device control part 10. The optical switch control feeder line 4 controls and feeds the optical switch part 2.

The communication optical signal extraction parts 5-0 and 5-1 extract some of communication optical signals from the communication optical fibers F-0 and F-1 and photoelectrically convert the extracted part of communication optical signals. The communication optical signal storage part 6 stores some of the communication optical signals photoelectrically converted in the communication optical signal extraction parts 5-0 and 5-1 and uses the stored energy to drive each of the processing parts such as the optical switch part 2.

Here, only the communication optical signal extraction part 5-0 may extract a part of the communication optical signal only from the communication optical fiber F-0. On the other hand, only the communication optical signal extraction part 5-1 may extract a part of the communication optical signal only from the communication optical fiber F-1. Note that the details of the communication optical signal extraction parts 5-0 and 5-1 will be described later in the first to third embodiments.

The prisms 7-0 and 7-1 extract some of communication optical signals from the communication optical fibers F-0 and F-1. The optical sensors 8-0 and 8-1 photoelectrically convert some of the extracted communication optical signals. The optical path switching monitoring part 9 monitors optical path switching between the communication optical fibers F-0 and F-1 using some of the photoelectrically converted communication optical signals in accordance with the command from the node device control part 10. Note that the node device control part 10, the coupler 11, the photodetector 12, the MEMS switch 13, and the circulator 14 will be described later in the third embodiment.

Since it is only necessary to photoelectrically convert the communication optical signal in this way, remote optical path switching can be performed in the access field without installing a device for transmitting a laser beam in the telecommunications carrier equipment P and without increasing the number of optical fiber core wires for power supply.

### Configuration of Optical Line Switching Node Device According to First Embodiment of Present Disclosure

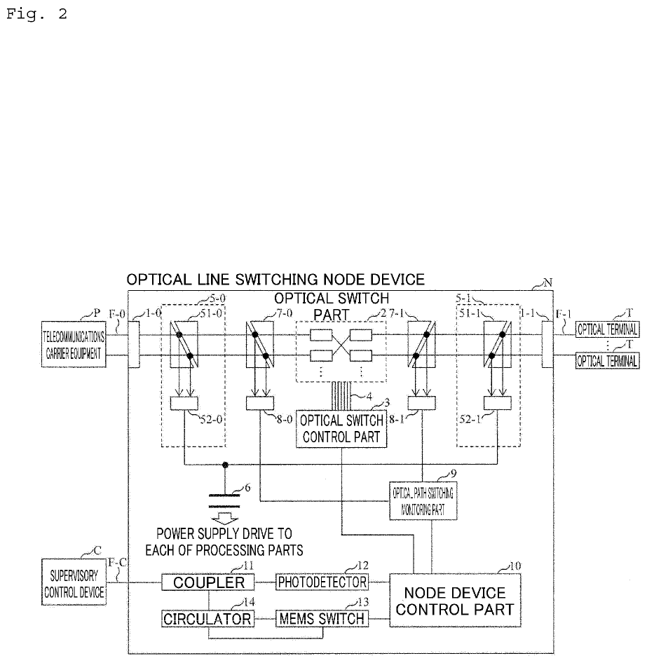

FIG. 2 illustrates a configuration of the optical line switching node device according to the first embodiment of the present disclosure. The communication optical signal extraction parts 5-0 and 5-1 extract some of communication optical signals from the communication optical fibers F-0 and F-1, in “parallel” with the prisms 7-0 and 7-1 attached to the optical path switching monitoring part 9.

Specifically, the communication optical signal extraction parts 5-0 and 5-1 include prisms 51-0 and 51-1 and photoelectric conversion elements 52-0 and 52-1. The prisms 51-0 and 51-1 use Fresnel reflection or the like to extract some of the communication optical signals from the communication optical fibers F-0 and F-1. The photoelectric conversion elements 52-0 and 52-1 are optical sensors or the like and photoelectrically convert some of the extracted communication optical signals. The communication optical signal storage part 6 is a storage capacitor or the like, stores some of the photoelectrically converted communication optical signals, and drives each of the processing units such as the optical switch part 2.

For example, the incident light power per core of the communication optical fiber F-0 is set to 10 mW and the number of cores of the communication optical fiber F-0 accommodated in the integrated connector 1-0 is set to 20 cores. Assuming that the optical loss of the integrated connector 1-0 is 0.5 dB (90% transmission), the incident light power after passing through the integrated connector 1-0 is 10 mW×20 fibers×90%=180 mW. Assuming that the light reflection of the prism 51-0 is 10%, the incident light power after the reflection of the prism 51-0 is 180 mW×10%=18 mW. Assuming that the conversion efficiency of the photoelectric conversion element 52-0 is 30%, the storage power after conversion of the photoelectric conversion element 52-0 is 18 mW×30%=5.4 mW.

Here, the communication optical fibers F-0 and F-1 always propagate communication optical signals. Thus, the communication optical signal storage part 6 can obtain sufficient electric power to drive each of the processing parts such as the optical switch part 2 even if only some of the communication optical signals is photoelectrically converted.

In this way, the communication optical signal extraction part 5 can be installed in “parallel” with the optical path switching monitoring part 9 and the power storage mode and the monitoring mode can be performed at “parallel” timings.

### Configuration of Optical Line Switching Node Device According to Second Embodiment of Present Disclosure

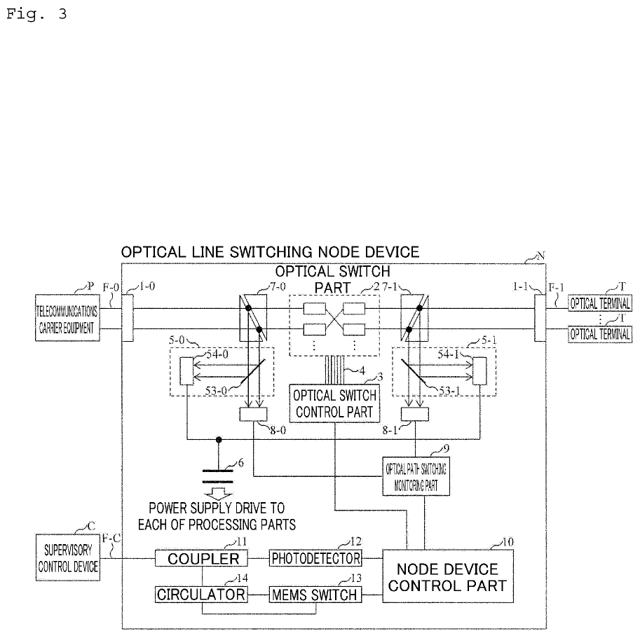

FIG. 3 illustrates a configuration of an optical line switching node device according to a second embodiment of the present disclosure. The communication optical signal extraction parts 5-0 and 5-1 extract some of communication optical signals from communication optical fibers F-0 and F-1 through “integration” with the prisms 7-0 and 7-1 attached to the optical path switching monitoring part 9. Here, the charging mode of some of the communication optical signals using the communication optical signal storage part 6 and the optical path switching monitoring mode using the optical path switching monitoring part 9 are performed at “parallel” timing.

Specifically, the communication optical signal extraction parts 5-0 and 5-1 include half mirrors 53-0 and 53-1 and photoelectric conversion elements 54-0 and 54-1. The prisms 7-0 and 7-1 use Fresnel reflection or the like to extract some of the communication optical signals from the communication optical fibers F-0 and F-1. The half mirrors 53-0 and 53-1 transmit/reflect some of the extracted communication optical signals. The photoelectric conversion elements 54-0 and 54-1 are optical sensors or the like and photoelectrically convert some of the reflected communication optical signals. The communication optical signal storage part 6 is a storage capacitor or the like, stores some of the photoelectrically converted communication optical signals, and drives each of the processing parts such as the optical switch part 2.

For example, the incident light power per core of the communication optical fiber F-0 is set to 10 mW and the number of cores of the communication optical fiber F-0 accommodated in the integrated connector 1-0 is set to 20 cores. Assuming that the optical loss of the integrated connector 1-0 is 0.5 dB (90% transmission), the incident light power after passing through the integrated connector 1-0 is 10 mW×20 fibers×90%=180 mW. Assuming that the light reflection of prism 7-0 is 10%, the incident light power after reflection of prism 7-0 is 180 mW×10%=18 mW. Assuming that the light reflection and light transmission of the half mirror 53-0 are 70% and 30%, respectively, the incident light power after reflection of the half mirror 53-0 is 18 mW×70%=12.6 mW. Assuming that the conversion efficiency of the photoelectric conversion element 54-0 is 30%, the storage power after conversion of the photoelectric conversion element 54-0 is 12.6 mW×30%=3.8 mW.

Here, the communication optical fibers F-0 and F-1 always propagate communication optical signals. Thus, the communication optical signal storage part 6 can obtain sufficient electric power to drive each of the processing units such as the optical switch part 2 even if only some of the communication optical signals are photoelectrically converted.

In this way, the communication optical signal extraction part 5 can be installed “integrally” with the optical path switching monitoring part 9 and the power storage mode and the monitoring mode can be performed at “parallel” timing.

### Configuration of Optical Line Switching Node Device According to Third Embodiment of Present Disclosure

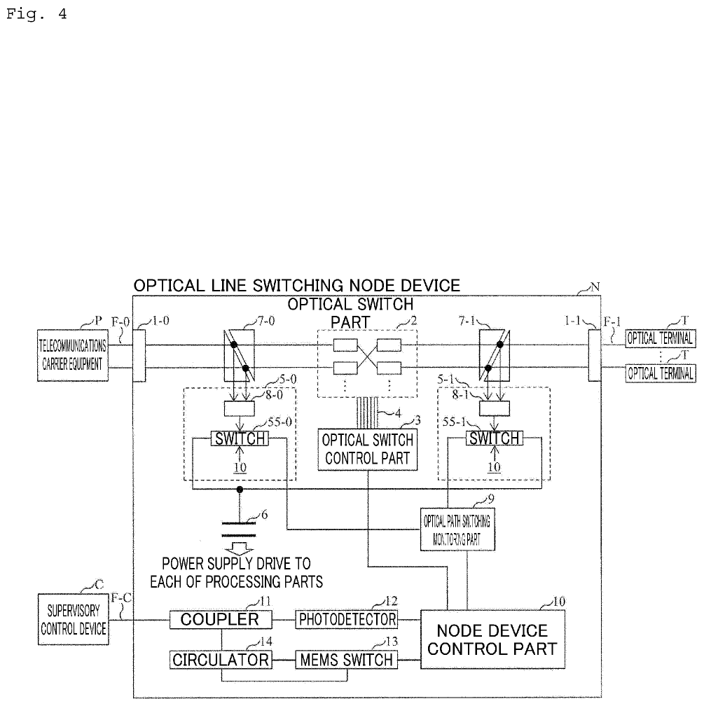

FIG. 4 illustrates a configuration of an optical line switching node device according to a third embodiment of the present disclosure. The communication optical signal extraction parts 5-0 and 5-1 extract some of communication optical signals from communication optical fibers F-0 and F-1 through “integration” with the prisms 7-0 and 7-1 attached to the optical path switching monitoring part 9. Here, the charging mode of some of the communication optical signals using the communication optical signal storage part 6 and the optical path switching monitoring mode using the optical path switching monitoring part 9 are performed at “alternate” timings.

Specifically, the communication optical signal extraction parts 5-0 and 5-1 include optical sensors 8-0 and 8-1 and switches 55-0 and 55-1. The prisms 7-0 and 7-1 use Fresnel reflection or the like to extract some of the communication optical signals from the communication optical fibers F-0 and F-1. The optical sensors 8-0 and 8-1 photoelectrically convert some of the extracted communication optical signals. The switches 55-0 and 55-1 are electrically driven switches or the like and switch between the power storage mode and the monitoring mode at “alternate” timing. The communication optical signal storage part 6 is a storage capacitor or the like, stores some of the photoelectrically converted communication optical signals, and drives each of the processing parts such as the optical switch part 2.

For example, the incident light power per core of the communication optical fiber F-0 is set to 10 mW and the number of cores of the communication optical fiber F-0 accommodated in the integrated connector 1-0 is set to 20 cores. Assuming that the optical loss of the integrated connector 1-0 is 0.5 dB (90% transmission), the incident light power after passing through the integrated connector 1-0 is 10 mW×20 fibers×90%=180 mW. Assuming that the light reflection of prism 7-0 is 10%, the incident light power after reflection of prism 7-0 is 180 mW×10%=18 mW. Assuming that the conversion efficiency of the optical sensor 8-0 is 30%, the storage power after conversion of the optical sensor 8-0 is 18 mW×30%=5.4 mW. Considering an actual operation, if a time ratio of the power storage mode and the monitoring mode of the switch 55-0 is 95%:5%, the power for power storage when the switch 55-0 is switched is 5.4 mW×95%=5.1 mW.

Here, the communication optical fibers F-0 and F-1 always propagate communication optical signals. Thus, the communication optical signal storage part 6 can obtain sufficient electric power to drive each of the processing parts such as the optical switch part 2 even if only some of the communication optical signals are photoelectrically converted.

In this way, the communication optical signal extraction part 5 can be installed “integrally” with the optical path switching monitoring part 9 and the power storage mode and the monitoring mode can be performed at “alternating” timings.

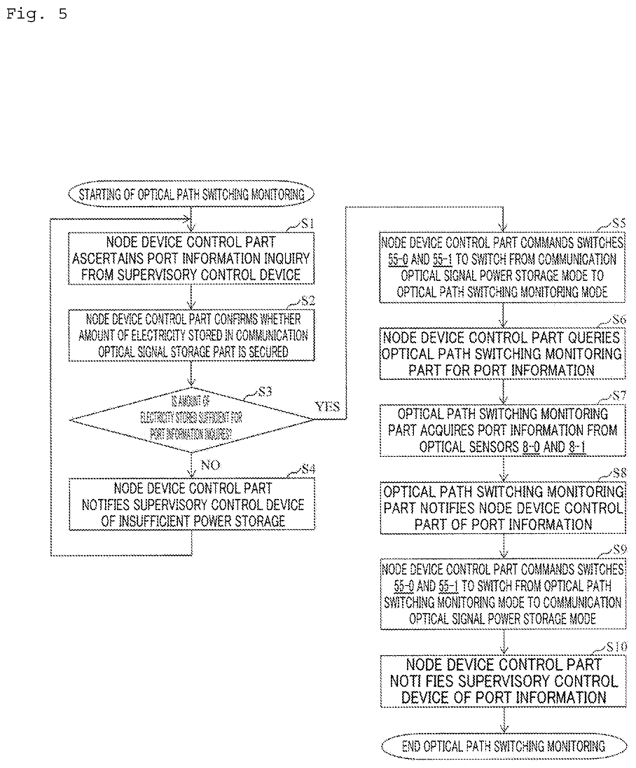

FIG. 5 illustrates a procedure of an optical path switching monitoring process according to a third embodiment of the present disclosure. The monitoring mode of optical path switching using the optical path switching monitoring part 9 is performed at the timing at which an amount of electricity stored of some of the communication optical signals in the communication optical signal storage part 6 is secured. Specifically, the following processes are performed.

The node device control part 10 receives an inquiry about port information from the supervisory control device C via the coupler 11 and the photodetector 12 (Step S1). The port information is port information for optical path switching between the communication optical fibers F-0 and F-1. The node device control part 10 confirms whether the amount of electricity stored in the communication optical signal storage part 6 can be secured (Step S2).

If the amount of electricity stored using the communication optical signal storage part 6 is not sufficient for querying the port information (Step S3, NO), the node device control part 10 notifies the supervisory control device 11 of insufficient power storage via the MEMS switch 13, the circulator 14 and the coupler 11 (Step S4). If the amount of electricity stored using the communication optical signal storage part 6 is sufficient for querying the port information (Step S3, YES), the node device control part 10 notifies the supervisory control device 11 of the port information via the MEMS switch 13, the circulator 14, and the coupler 11 (Step S10). Specifically, the processes of the following Steps S5 to S9 are performed.

The node device control part 10 commands the switches 55-0 and 55-1 to switch from the communication optical signal power storage mode to the optical path switching monitoring mode (Step S5). The node device control part 10 inquires about the port information to the optical path switching monitoring part 9 (Step S6). The optical path switching monitoring part 9 acquires port information from the optical sensors 8-0 and 8-1 (Step S7). The optical path switching monitoring part 9 notifies the node device control part 10 of the port information (Step S8). The node device control part 10 commands the switches 55-0 and 55-1 to switch from the optical path switching monitoring mode to the communication optical signal power storage mode (Step S9).

In this way, the stored energy can be used to perform the monitoring mode and the monitoring mode can be canceled if the energy is not stored.

### Configuration of Optical Line Switching Node Device According to Fourth Embodiment of Present Disclosure

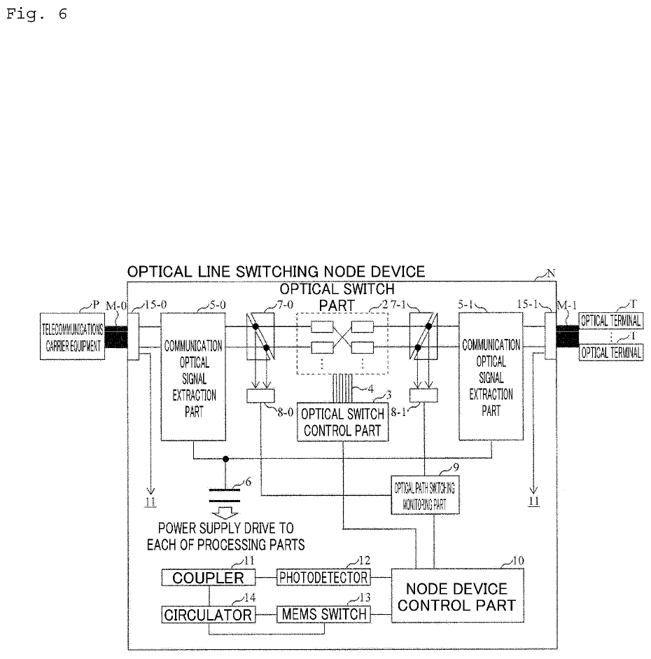

FIG. 6 illustrates a configuration of an optical line switching node device according to a fourth embodiment of the present disclosure. The communication optical fibers F-0 and F-1 are multi-core optical fibers M-0 and M-1 which include a communication single-core optical fiber which transmits a communication optical signal and a control single-core optical fiber which transmits an optical signal for control of the optical switch part 2. Here, the fourth embodiment can be applied to the first to third embodiments because the configuration of the communication optical signal extraction parts 5-0 and 5-1 does not matter. Furthermore, only the communication optical fiber F-0 may be the multi-core optical fiber M-0. On the other hand, only the communication optical fiber F-1 may be the multi-core optical fiber M-1.

At the time of terminating the multi-core optical fibers M-0 and M-1 to the optical line switching node device N, the multi-core optical fibers M-0 and M-1 are inserted into the fan-out connectors 15-0 and 15-1. Inside the optical line switching node device N, the multi-core optical fibers M-0 and M-1 are converted into single-core optical fibers. The communication single-core optical fiber is connected to the optical switch part 2 and the control single-core optical fiber is connected to the coupler 11.

In this way, it is only necessary to prepare only one multi-core optical fiber without separately preparing a communication single-core optical fiber and a control single-core optical fiber.

### INDUSTRIAL APPLICABILITY

The optical line switching node device of the present disclosure can perform remote optical path switching without installing a device which transmits a laser beam in telecommunications carrier's buildings or the like and without increasing the number of optical fiber core wires for power supply in the access field.

### REFERENCE SIGNS LIST

N Optical line switching node device
P Telecommunications carrier equipment
C Supervisory control device
T Optical terminal
F-0, F-1 Communication optical fiber
F-C Control optical fiber
M-0, M-1 Multi-core optical fiber
1-0, 1-1 Integrated connector
2 Optical switch part
3 Optical switch control part
4 Optical switch control feeder line
5-0, 5-1 Communication optical signal extraction part
6 Communication optical signal storage part
7-0, 7-1 Prism
8-0, 8-1 Optical sensor
9 Optical path switching monitoring part
10 Node device control part
11 Coupler
12 Photodetector
13 MEMS switch
14 Circulator
15-0, 15-1 Fan-out connector
51-0, 51-1 Prism
52-0, 52-1 Photoelectric conversion element
53-0, 53-1 Half mirror
54-0, 54-1 Photoelectric conversion element
55-0, 55-1 Switch

1. An optical line switching node device, comprising:
an optical switch part which performs optical path switching between communication input/output optical fibers;
a communication optical signal extraction part which extracts some of communication optical signals from one or both of the communication input/output optical fibers and photoelectrically converts the extracted some of the communication optical signals; and
a communication optical signal storage part which stores some of communication optical signals photoelectrically converted in the communication optical signal extraction part and uses the stored energy to drive the optical switch part.

2. The optical line switching node device according to claim 1, further comprising:
an optical path switching monitoring part which extracts some of communication optical signals from the communication input/output optical fibers, photoelectrically converts some of the extracted communication optical signals, and monitors optical path switching between the communication input/output optical fibers using some of the photoelectrically converted communication optical signals,
wherein the communication optical signal extraction part extracts some of the communication optical signals from one or both of the communication input/output optical fibers in parallel with the optical path switching monitoring part.

3. The optical line switching node device according to claim 1, further comprising:
an optical path switching monitoring part which extracts some of communication optical signals from the communication input/output optical fibers, photoelectrically converts some of the extracted communication optical signals, and monitors optical path switching between the communication input/output optical fibers using some of the photoelectrically converted communication optical signals,
wherein the communication optical signal extraction part extracts some of the communication optical signals from one or both of the communication input/output optical fibers through integration with the optical path switching monitoring part, and a power storage mode for some of the communication optical signals using the communication optical signal storage part and a monitoring mode for optical path switching using the optical path switching monitoring part are performed in parallel timing.

4. The optical line switching node device according to claim 1, further comprising:
an optical path switching monitoring part which extracts some of communication optical signals from the communication input/output optical fibers, photoelectrically converts some of the extracted communication optical signals, and monitors optical path switching between the communication input/output optical fibers using some of the photoelectrically converted communication optical signals,
wherein the communication optical signal extraction part extracts some of the communication optical signals from one or both of the communication input/output optical fibers through integration with the optical path switching monitoring part, and a power storage mode for some of the communication optical signals using the communication optical signal storage part and a monitoring mode for optical path switching using the optical path switching monitoring part are performed at alternate timings.

5. The optical line switching node device according to claim 4, wherein the optical path switching monitoring mode using the optical path switching monitoring part is performed at a timing at which the amount of electricity stored of some of the communication optical signals in the communication optical signal storage part is secured.

6. The optical line switching node device according to claim 1, wherein one or both of the communication input/output optical fibers are a multi-core optical fiber which includes a communication single-core optical fiber which transmits a communication optical signal and a control single-core optical fiber which transmits a control optical signal of the optical switch part.
